(19) United States
(12) Patent Application Publication
(10) Pub. No.: US 2026/0160095 A1
(43) Pub. Date: Jun. 11, 2026

(54) ELECTRONIC LOCK ASSEMBLY

(71) Applicant: Kenstan Lock and Hardware Company, Inc., Plainview, NY (US)

(72) Inventors: Wayne Nemeth, Rye, NY (US); Kevin Fundarek, Brightwaters, NY (US); Hans Bosch, Vero Beach, FL (US); Harinarain Singh, East Northport, NY (US)

(21) Appl. No.: 19/414,202

(22) Filed: Dec. 9, 2025

Related U.S. Application Data
(60) Provisional application No. 63/729,671, filed on Dec. 9, 2024.
(60) Provisional application No. 63/729,662, filed on Dec. 9, 2024.

(51) Int. Cl. E05B 47/00

(52) U.S. Cl. CPC E05B 47/0012; E05B 2047/0017; E05B 2047/0022; E05B 2047/0058; E05B 2047/0095

(57) ABSTRACT

An electronic lock includes an exterior housing, a lock core, an interior lock housing, a knob, and an arming mechanism. The lock core can include a core spindle and a core shell that together define a key opening, or a dummy lock core. When the lock core includes a core spindle and a core shell, the core spindle is rotatable within the core shell upon insertion of an authorized physical key. The interior lock housing is rotatably received within the exterior housing and defines a cylindrical cavity that receives the lock core. The interior lock housing is rotatable within the exterior housing to rotate the lock core within the exterior housing. The arming mechanism is supported within the exterior housing and includes an arming member that is movable from an armed position engaged with the interior lock housing to a disarmed position disengaged from the interior lock housing. The knob is coupled to the interior lock housing and is rotatable to rotate the interior lock housing and the lock core within the exterior housing. The knob can be coupled to the interior lock housing by a torque limiting mechanism that allows the knob to rotate independently of the interior lock housing when a twisting force applied to the knob exceeds a predetermined threshold.

### CROSS-REFERENCE TO RELATED APPLICATIONS

This application claims the benefit of, and priority to, U.S. Provisional Patent Application Ser. No. 63/729,671, filed on Dec. 9, 2024 and U.S. Provisional Patent Application Ser. No. 63/729,662, filed on Dec. 9, 2024. The entire contents of the foregoing applications are incorporated by reference herein.

### TECHNICAL FIELD

This application is directed to electronic locks, and more particularly, to electronic locks for fixtures.

### BACKGROUND

Electronic locks have been frequently used for home and building access doors. However, there is a need for a new generation of full-featured compact electronic locks that provide security, access control and usage data for fixtures, such as cabinets, cases, drawers, storage, lockers, etc. This new generation of wireless lock is battery powered or wired to power and has intelligence built into the lock such that it's able to make access control decisions in coordination with an organization's global access control standards and security requirements.

Electronic locks provide organizations such as retailers, hospitals, schools, governmental agencies and gyms better digital security, near real-time changes to access control, historical tracking, centralized control, threat alerts, and ultimately operational savings.

Key management is one of the biggest challenges to organizational security, especially when managing many locks with many users whose access privileges may be frequently changing, as is the case in retail stores. Security breaches in physical locks and keys typically involve replacing or rekeying lock cores and reissuing keys with a new key pattern. Solutions attempting to use battery powered electronic smart keys to provide security and tracking, and in some designs power to the lock from the key, all increase operational complexity and cost. Thus, there is a need for a smart lock with digital wireless access and independent power and intelligence, which can simplify the operational challenges and cost of managing multiple physical keys, while still offering the option of a physical key as secondary means of access.

### BRIEF DESCRIPTION OF THE DRAWINGS

A better understanding of the features and advantages of the disclosed technology will be obtained by reference to the following detailed description that sets forth illustrative aspects, in which the principles of the technology are utilized, and the accompanying drawings of which:

FIG. 1 is a schematic diagram of a lock management system according to aspects of the disclosure;

FIG. 2 is a schematic diagram of an electronic lock according to aspects of the disclosure;

FIG. 3A is a top view of the electronic lock of FIG. 2;

FIG. 3B is a side view of the electronic lock of FIG. 2;

FIG. 3C is a front view of the electronic lock of FIG. 2;

FIG. 4 is a side, perspective view of the electronic lock of FIG. 3;

FIG. 5 is a side, perspective view of a ratchet type electronic lock according to further aspects of the disclosure;

FIG. 6 is a side, perspective view of a padlock type electronic lock according to aspects of the disclosure;

FIG. 7 is a side, perspective view of a plunger type electronic lock according to aspects of the disclosure;

FIG. 8 is a front view of the electronic lock of FIG. 3 with a front cover removed;

FIG. 9 is a side view of the electronic lock shown in FIG. 8 with a side wall of the electronic lock shown in phantom;

FIG. 10 is a side cross-sectional view taken through a portion of the electronic lock shown in FIG. 9;

FIG. 11 is a side cross-sectional view taken through a portion of the electronic lock shown in FIG. 9;

FIGS. 12A-12D are schematic views illustrating the electronic lock in four different states;

FIG. 13 is a side cross-sectional view taken through an alternate version of the electronic lock shown in FIG. 10.

Further exemplary aspects of the disclosure are described in more detail below with reference to the appended figures. Aspects of this disclosure may be combined without departing from the scope of the disclosure.

### DETAILED DESCRIPTION

Reference will now be made in detail to aspects of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

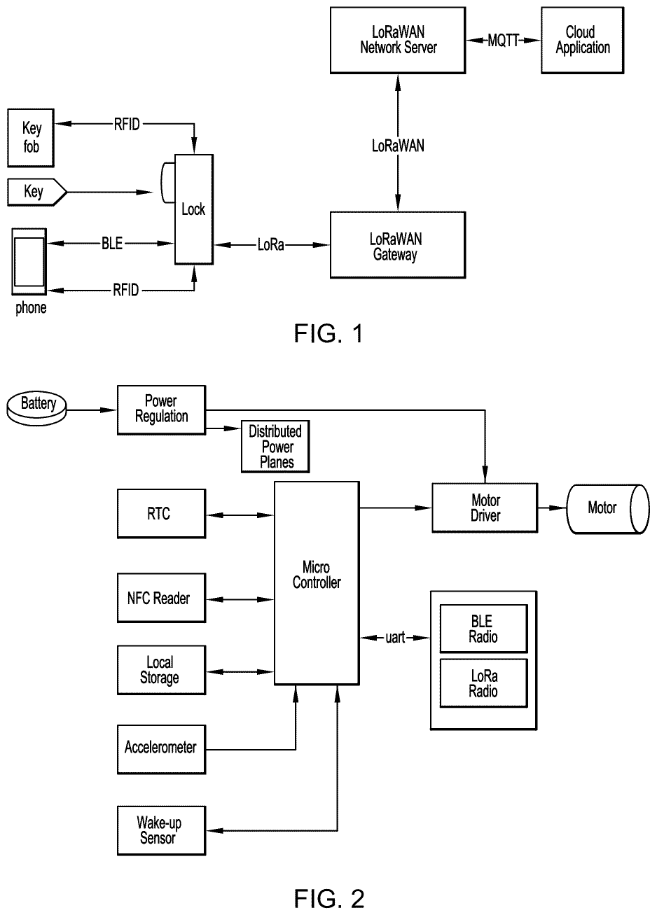

With reference to FIG. 1, a high-level design of a lock management system for a lock, e.g., lock 10 (FIG. 4) is shown. When an RFID card is presented to the lock 10, the card which contains a secure RFID chip will be read by the lock 10. When a mobile device, such as a mobile phone or store computer running a custom application is used, the mobile device will recognize the lock 10 by reading an RFID chip positioned inside the lock 10. The mobile device may also include an RFID chip that is readable by the lock 10. Then the phone will use secure Bluetooth to connect to the lock 10 and transmit an authorization code to the lock 10. The lock 10 stores a list of authorized codes and will compare the authorized codes to the authorization codes transmitted from the phone.

The lock 10 communicates with a wireless gateway using any suitable wireless protocol, such as LoRa. LoRa is used to send data from the device to a LoRa gateway. From the LoRa gateway, the data is pushed to a LoRa Network Server which can then parse the data and send it to a cloud software platform. In some configurations, the mobile device can function as a gateway for communication with the cloud software platform. This would be an alternative to the LoRaWAN gateway.

The system includes the following components:

Key Fob and RFID Tag: The key fob and RFID tag are physical devices equipped with secure RFID chips. When presented to the RFID reader of the lock 10, the key fob and RFID tag transmit unique data, e.g., a code or codes, to validate the user's access. The lock 10 compares this unique data with a locally stored list of authorized devices to grant or deny access.

Physical Key: The physical key is a mechanical key that serves as a backup access mechanism. The physical key can be used as an alternative to electronic methods in situations where electronic methods are unavailable.

Mobile Phone: The mobile phone functions as a versatile access tool, enabling both Bluetooth Low Energy (BLE) and RFID/NFC-based interactions with the lock 10. The phone may also act as a gateway to facilitate communication with the cloud, providing an alternative to dedicated infrastructure. Through BLE, the phone transmits secure authorization credentials, such as a Time-based One-Time Password (TOTP), to the lock 10.

Lock: The central device in the system, the lock, e.g., lock 10, integrates both RFID and BLE modules to support diverse access methods. The lock 10 maintains a local database of authorized devices and codes and performs validation independently, ensuring uninterrupted operation even without cloud connectivity. The local database of authorized devices and codes is periodically updated when cloud connectivity with the lock 10 is available. The lock 10 also transmits operational and access data to external systems.

Wireless Gateway: The wireless gateway serves as a bridge between the lock and a network server to transmit data from the lock to the network server using a long-range, low-power wireless communication protocol suitable for battery-operated devices such as the lock 10 of the present disclosure. LoRaWAN is one such example of this type of protocol, enabling efficient and secure transmission of lock data over long distances.

Network Server: The network server receives data from the wireless gateway, processes it, and relays the data to the cloud application for centralized access control and monitoring. The network also supports updates to the access control data of the lock 10.

Cloud Application: The cloud-based management platform provides centralized control over the entire system to facilitate updates to the lock's database of authorized devices, schedules, and configuration settings. Communication between the network server and the cloud is managed using efficient protocols like MQTT, ensuring secure and reliable data transfer.

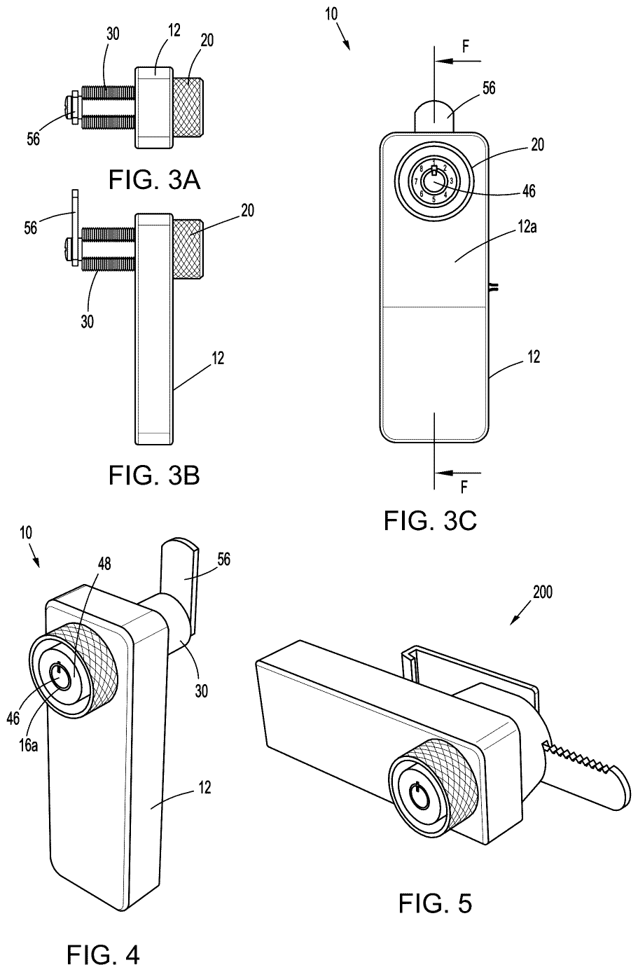

With reference to FIGS. 2 and 3, the lock 10 includes a microcontroller, which acts as the central processing unit, coordinating all operations within the lock 10. The microcontroller is responsible for interfacing with peripheral components such as the NFC Reader, BLE Radio, LoRa Radio, Local Storage, Motor Driver, and various sensors. The microcontroller communicates with these components through standard protocols like SPI (Serial Peripheral Interface) and UART (Universal Asynchronous Receiver-Transmitter).

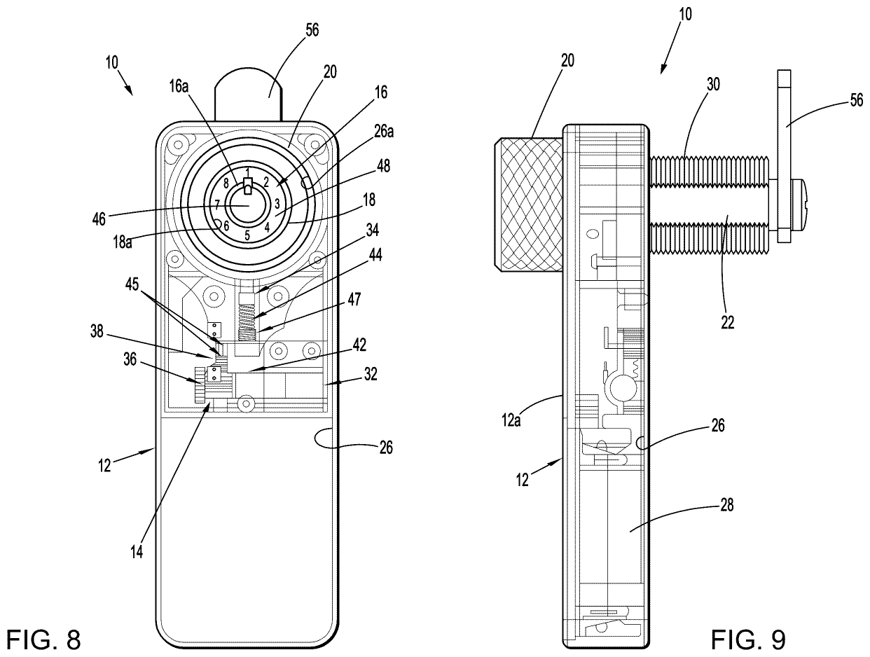

The lock 10 is powered by a battery, whose output is regulated by a Power Regulation unit. This ensures stable power delivery across distributed power planes, catering to both high-power components like a motor 32 (FIG. 8) and low-power components like the sensors and communication modules.

A motor driver and the motor 32 together enable the physical locking and unlocking mechanisms. The microcontroller sends commands to the motor driver to actuate the motor 32, which, as described below, physically secures or releases the lock 10. The distributed power planes from the power regulation unit provide sufficient energy for motor operations.

The BLE Radio and LoRa Radio are responsible for wireless communication. The BLE Radio supports short-range communication with mobile devices, enabling secure data exchange and user access through features like Bluetooth-based key sharing. The LoRa Radio, as an example of a long-range, low-power wireless communication technology, allows the lock 10 to transmit data to external servers or gateways over large distances, enabling cloud-based management.

The NFC Reader interacts with RFID tags, key fobs, or mobile phones, providing an additional method for user authentication. This reader communicates with the microcontroller via the SPI interface.

Local Storage is used to maintain an on-device access control list, ensuring that the lock can validate access locally without relying on real-time connectivity to the cloud. This improves resilience by allowing the lock to function during network outages.

The Real-Time Clock (RTC) enables time-sensitive functionalities, such as access scheduling and logging, ensuring that access permissions adhere to specific time constraints.

The system includes an Accelerometer (e.g., LIS3DH) and a Wake-Up Sensor. The accelerometer can detect tampering or unauthorized physical movements, triggering security responses or alerts. The wake-up sensor minimizes power consumption by keeping the system in low-power mode until an interaction, such as proximity detection or vibration, occurs.

Together, these components form a cohesive, power-efficient system that supports a blend of advanced security features, local autonomy, and cloud connectivity. The modular design allows for scalability and customization, catering to a wide range of use cases and operational environments.

Because the lock 10 can either be opened with a mobile phone enabled with NFC and Bluetooth or an NFC/RFID tag, the lock 10 includes both an NFC/RFID reader and a NFC/RFID tag. The Bluetooth and LoRa radio may create wireless interference such that the NFC/RFID reader and NFC/RFID tag need to be placed in different locations on the lock, and RF shielding is used to prevent interference.

The lock also incorporates Power Management. In particular, the microcontroller goes into lower power mode until one or more of the following actions “wake it up”:
Internal timer is set for wake-ups on a regular interval;
Proximity sensor is triggered;
RFID tag or phone is presented to reader;
Accelerometer or motion detection is triggered; or
Theft Identification using a motion sensor or accelerometer.

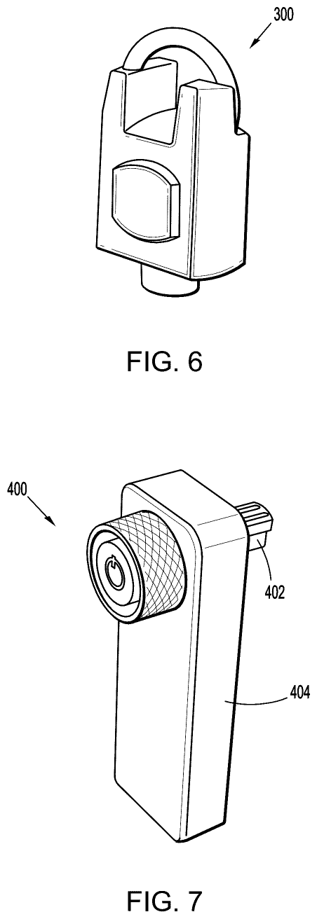

The electronics, software, and basic mechanical functionality of the lock 10, including the physical lock and key may support multiple fixture locking designs including cam locks 10 (FIG. 4), ratchet locks 200 (FIG. 5), padlock locks 300 (FIG. 6), plunger locks 400 (FIG. 7), bolt locks, drawer locks, and snap bolt locks. In a plunger lock, unlike the other lock types, the plunger lock core 402 moves axially into and out of an exterior housing 404.

FIGS. 8-11 illustrate aspects of an electronic cam lock shown generally as lock 10. The lock 10 includes an external housing 12, an arming mechanism 14, a lock core 16, an interior lock housing 18, a knob 20, a main driver 22, and a bolt 56. The lock 10 may also include a secondary driver (not shown) to connect the main driver 22 to the bolt 56. The secondary driver when used is concentric and radially fixed to the main driver 22 but is axially flexible to allow the lock 10 to be coupled to fixtures of different thicknesses.

The exterior housing 12 defines a cavity 26 that receives the lock components including the electronics, mechanical systems, and a power source 28, e.g., a battery. In aspects of the disclosure, the cavity 26 includes a cylindrical portion 26a. The exterior housing 12 also includes or supports a hollow threaded shaft 30 for securing the exterior housing 12 to a fixture, e.g., cabinets, cases, drawers, storage, lockers, etc. The threaded shaft 30 defines the cylindrical portion 26a of the cavity 26. It is envisioned that the shaft 30 need not be cylindrical but could have a variety of configurations including rectangular or oval. The exterior housing 12 includes a front cover 12a that is formed of a material that allows the internal lock components to transmit and receive RF signals.

The arming mechanism 14 includes an electrical motor 32, an arming member 34, and an actuator 36. The electrical motor 32 is coupled to the actuator 36 and is operable to move the arming member 34 between armed and disarmed positions. In aspects of the disclosure, the arming member 34 includes a pin, and the actuator 36 includes a rack 38 and a pinion gear 40 that is coupled to the electrical motor 32 by a planetary gear box 42. In use, the electrical motor 32 drives the pinion gear 40 to move the rack 38 to move the arming member or pin 34 between the armed and disarmed positions. In some aspects of the disclosure, the arming mechanism 14 includes a spring 44 for urging the arming member 34 to the armed position. The spring 44 and the pin 34 can be received within a housing 47 formed or included in the exterior housing 12. The arming mechanism 14 may also include a limit switch or switches 45 for deactivating the electrical motor 32 when the arming member 34 reaches the armed position. It is also envisioned that the arming member 34 and the actuator 36 can have a variety of configurations other than a rack 38 and pinion gear 40 and a pin 34.

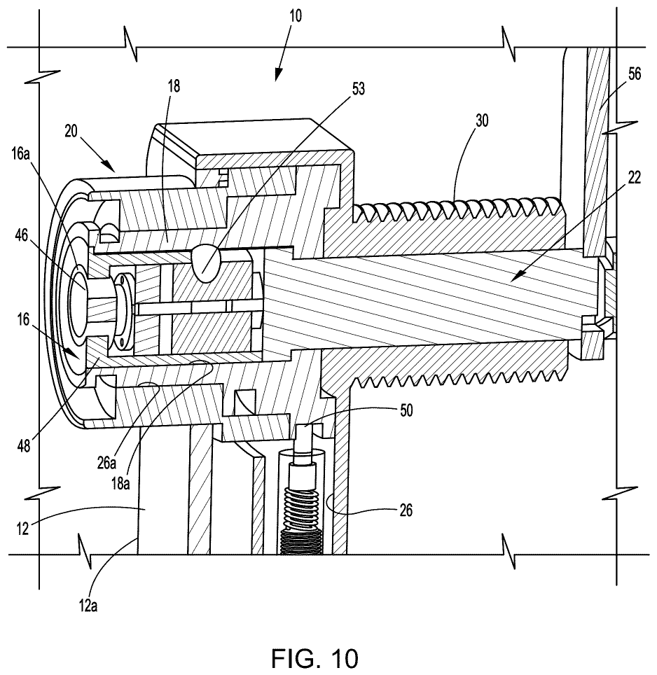

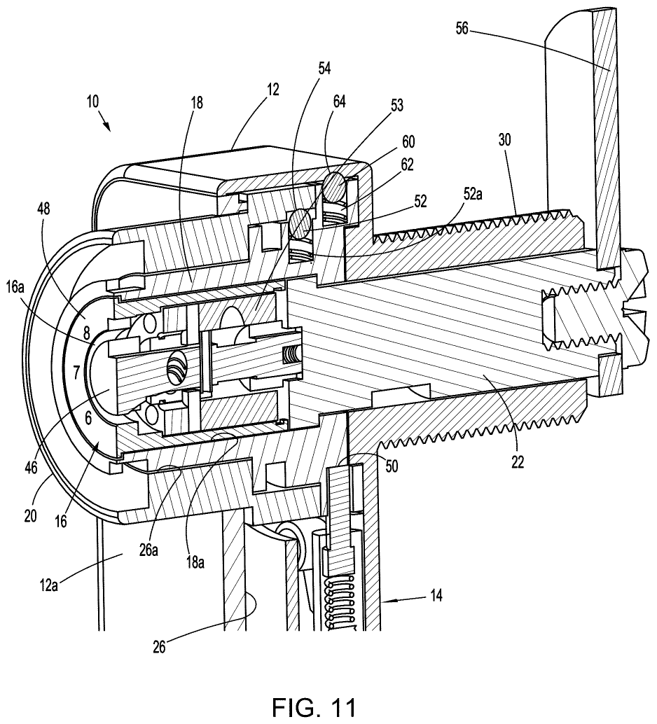

As illustrated in FIGS. 10 and 11, the lock core 16 includes a core spindle 46, a core shell 48, and a pin assembly 53. The core spindle 46 and the core shell 48 define a key opening 16a. The pin assembly 53 secures the core spindle 46 to the core shell 48 unless uncoupled by a key (not shown) to facilitate rotation of the core spindle 46 within the core shell 48. In some aspects of the disclosure, the lock core 16 is removable from the inner lock housing 18 and can be replaced in the event of a lost key or damage to the lock core 16.

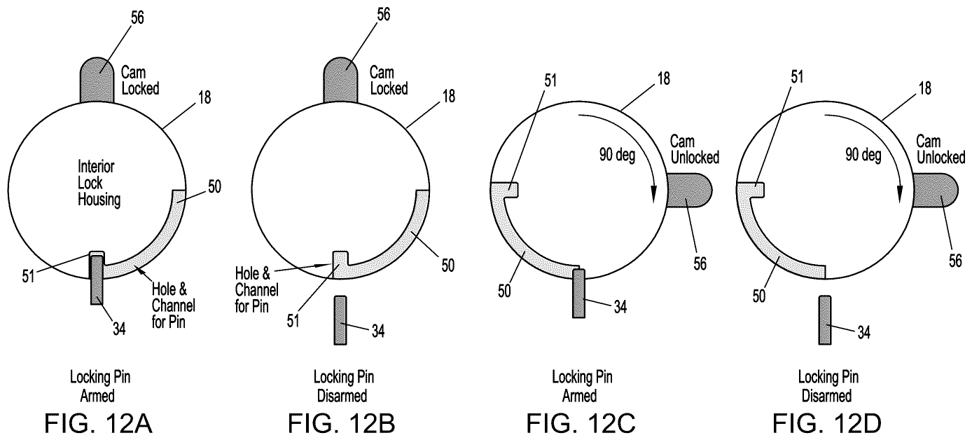

The interior lock housing 18 is received within the cylindrical portion 26a of the cavity 26 of the exterior housing 12 and defines a cylindrical cavity 18a that receives the lock core 16. In aspects of the disclosure, the interior lock housing 18 defines a channel 50 and a recess or opening 51 (FIG. 12A) that receives the arming member 34 when the arming member 34 is in an armed position. In the armed position, the arming member 34 is engaged with the interior lock housing 18 to prevent rotation of the interior lock housing 18 within the exterior housing 12. In the disarmed position, the arming member 34 is disengaged from the interior lock housing 18 to facilitate rotation of the interior lock housing 18 within the exterior housing 12. The lock core 16 is received within the cylindrical cavity 18a of the interior lock housing 18 and is rotatable with the interior lock housing 18 when the arming mechanism 14 is in the disarmed position.

The knob 20 is received about and coupled to the interior lock housing 18 such that rotation of the knob 20 causes corresponding rotation of the interior lock housing 18. In aspects of the disclosure, the knob 20 is coupled to the interior lock housing 18 by a a torque limiting mechanism such as a friction clutch, springs, magnets, compliant features, or the like. A ball detent mechanism includes one or more spring-loaded balls 52 that are received within detents 54 formed in the interior lock housing 18, and one or more springs 52a to urge the balls 52 into the detents and releasably couple the knob 20 to the interior lock housing 18. When the knob 20 is rotated with the arming mechanism 14 in the armed position, the balls 52 will disengage from the detents 54 to allow the knob 20 to rotate independently of the interior lock housing 18 to prevent damage to the internal components of the lock 10. When the knob 20 is rotated with the arming mechanism 14 in the disarmed position, the knob 20 will rotate the interior lock housing 18 and the lock core 16 within the exterior housing 12 to move the bolt 56 between a locked position and an unlocked position.

The main driver 22 is connected to the core spindle 46 on the front of the lock 10 and to the bolt 56 (or a cam or other type of locking mechanism) on the back of the lock 10. The main driver 22 rotates between the locked and unlocked position when either (1) an authorized physical key unlocks and then rotates the core spindle 46 which thereby rotates the main driver 22 while the interior lock housing 18 and core shell 48 remain stationary, or (2) the arming member 34, e.g., the pin 34, is deactivated and the knob 20 is manually turned, thereby turning the interior lock housing 18, core shell 48, core spindle 46, and main driver 22 all as one assembly. In aspects of the disclosure, the main driver 22 may use single or multiple pressure-sensitive balls 60 and springs 62 (ball detents) to rotationally register the main driver 22 in either or both the locked and unlocked position. Rotationally registering the main driver 22 in the locked and/or unlocked positions may result in a better user feel when turning the knob 20, lower binding forces on the arming mechanism 14 when moving from the locked to the unlocked positions, and prevention of inadvertent rotation when the lock 10 is intended to stay in either the locked or unlocked position. In aspects of the disclosure, the balls 60 can be supported on an outer surface of the interior lock housing 18 and detents 64 can be formed in an inner surface of the exterior housing 12.

FIG. 12A-12D illustrate the four states of the lock 10. FIG. 12A illustrates the lock 10 in an armed and locked state. In the armed and locked state, the arming member or pin 34 is engaged with the interior lock housing 18 to prevent manual rotation of the interior lock housing 18 to the unlocked position and the bolt 56 is in the locked position.

FIG. 12B illustrates the lock 10 in a disarmed and locked position. In this position, the arming member or pin 34 is disengaged from the interior lock housing 18 but the bolt 56 has not been moved from the locked position to the unlocked position. Since the arming member 34 is disengaged from the interior lock housing 18, the knob 20 can be manually rotated to rotate the interior lock housing 18 and the bolt 56 to the unlocked position.

FIG. 12C illustrates the lock 10 in the armed and unlocked position. In this position, the arming member is moved into the channel 50 and the interior lock housing 18 is rotated by the knob 20 to rotate the lock core 16 and the bolt 56 to the unlocked position. As shown, in this position, the arming member or pin 34 is received within the channel 50 of the interior lock housing 18 spaced from the opening or recess 51 in an armed position. When the interior lock housing 18 is manually rotated back to the locked position, the arming member 34 will automatically (via spring 44) move into the opening or recess 51 to prevent manual actuation of the lock 10.

FIG. 12D illustrates the lock 10 in the disarmed unlocked position with the arming member 34 disengaged from the interior lock housing 18 and the bolt 56 in the unlocked position. In some aspects of the disclosure, the lock 10 can be programmed to move the arming member 34 to the armed position after a predetermined period of time after the arming member 34 is moved to the disarmed position, e.g., 3-5 seconds.

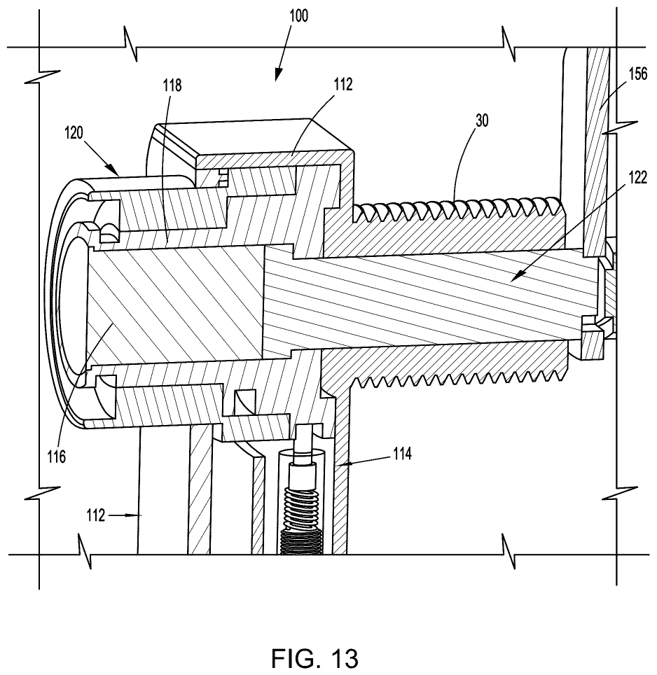

FIG. 13 illustrates an alternate version of the electronic lock 10 shown generally as lock 100. The lock 100 is substantially similar to lock 10 (FIG. 11) and includes an exterior housing 112, an interior lock housing 118, a knob 120 rotatably supported about the lock housing 120, a main driver 122, and a bolt 156. The lock 100 differs from the lock 10 in that the lock core 16 (FIG. 10) is replaced with a dummy core 116. The dummy core 116 is a unitary component that is rotatably fixed to the lock housing 118 and to the main driver 122 but does not have a key slot. The lock 100 is not operable with a key and can only be operated with electronically as described above. The lock 100 also includes an arming mechanism 114 as described above and operates electronically as described above.

The lock 100 can be operated electronically by disarming the lock 100 wirelessly using one of the methods disclosed above and subsequently rotating the knob 120 to move the lock 100 from the locked position and the unlocked position. It is envisioned that the dummy core 116 can be selectively replaced with a lock core 16 (FIG. 10) to facilitate mechanical unlocking of the lock 100 with a physical key.

Although the lock 10 is shown to have a rotatable knob 20 that rotates internal components of the lock 10, it is envisioned that the internal components of the lock 10 can be axially movable components such as found in a plunger style lock, e.g., lock 400 (FIG. 7). In plunger style locks, the knob can be manually retracted to move a plunger axially from a locked position to an unlocked position.

The cloud application consists of the following modules:
Administration—access rights and platform controls
Initial Commissioning—adding new locks or reassigning
Access Control—defines user groups and assigns rights to individuals or groups
Realtime Configurable Alerts—low battery, theft alerts and errors
Lock Dashboard and Status—lock location, state (locked or unlocked), battery level, etc.
Lock Activity History—historical view of lock activity by individual and time

A third party, such as a customer, can be given access to open a lock either by using (1) a mobile application on a device enabled with a key code security or (2) a browser. In a mobile application, key code security can be integrated with an existing mobile application including a retailer's mobile application for use in their store. The locking application can also be a stand-alone application only used for opening locks. In addition, customers in the store can use a browser to open locks without the need for using an application. They can first identify the lock by scanning a code, such as an RFID code, QR code, or bar code that links them to a website that knows what lock they are trying to open. The website can request the customer's mobile phone number and if that phone number is authorized to open the lock, the cloud software can text them an alphanumeric code that can be entered into the website through the browser. When the provided code is entered into the website, the cloud can open the lock through the wireless controller.

As described above, the knob 20 that is used to manually turn the lock 10 to the locked and unlocked positions is designed as an anti-twist collar to prevent users and/or those with the intent of breaking into the lock 10 from twisting the knob 20 and compromising the lock 10 and the installation. Break-in techniques may include pipe wrenches or other clamping devices that can be used as leverage when turning the knob 20. The anti-twist collar allows the knob 20 to be turned with enough force to lock and unlock the lock 10. However, when the twisting force exceeds a certain threshold, this force sensitive design allows the knob 20 to turn independently of the remaining components of the lock 10 without engaging other parts of the lock 10 that may be damaged from excess twisting forces. This type of twisting force sensitive design can be achieved by using the spring-loaded ball detents described above or other types of force limiting mechanisms including, e.g., a friction clutch, springs, magnets, and compliant features. The ball detent mechanism uses a spring-loaded ball to temporarily hold a part in place relative to another part by partially pushing a ball into a hole in one of the two parts that move relative to each other. When a threshold force is applied to the knob 20, the spring is compressed, and the ball disengages from the hole allowing the parts to move relative to each other.

When the lock 10 is in the locked position, binding forces may prevent the arming member or pin 34 from retracting to the disarmed position. This is particularly important in electronic lock designs that use limited motor torque to retract the pin 34. To relieve this binding force caused by the arming member 34 binding in the hole 51, a mechanical centering device, e.g., balls 60 and detents 64 (FIG. 11), is used to force the rotating parts into a position that more exactly aligns the pin 34 with the hole 51 (or other locking methodologies) but still allows the knob 20 to be turned above a threshold turning force. It is envisioned that other types of mechanical or electrical centering devices can be used to force the rotating parts into a more precise position including springs, magnets, compliant features, or the like. This force sensitive centering design can be achieved by using the spring-loaded balls 60 and detents 64 or other types of centering mechanisms.

When the electronic lock senses unusual vibration that indicates the lock 10 is being tampered with, vibration sensing electronics in the lock 10, such as an accelerometer, is provided to send signals to a lock processor indicating a level of vibration. This signal may be sent back to the cloud software and either the cloud, the controller, or the lock 10 may trigger a tamper alert alarm based on the level of vibration sensed. The tamper alert may be in the form of an alert in the software, a text message, an audible noise, or some other form of alert.

One of the important features of an electronic lock is the ability for a battery powered lock to maintain operation when either store power or wireless connection is severed. The lock 10 has the ability to be opened with either a phone, enabled handheld store computer, RFID/NFC tag, card/FOB, or authorized physical key when store power or wireless is down.

Rather than using a LoRa controller or other centralized wireless controller, the locks may be controlled by a local or distributed controller (either wired or wireless).

Rather than using a LoRa controller or other centralized wireless controller, the locks may be controlled by a single or multiple mobile devices that connect wirelessly to the locks and provide access to the cloud.

The benefit of an interior mounted wireless fixture lock is that it remains partly hidden from view when the fixture is closed, and it is more difficult to tamper with it. This interior mounted lock can use many of the design features that an exterior mounted lock has, including all the electronics, software, functionality, security and access capability.

The lock 10 may also use wired power rather than battery power, or a combination of both. The lock 10 would include all the features and functionality of a battery powered lock.

Various embodiments of the systems, apparatuses, and methods have been described, and in many of the different embodiments many features are similar. To avoid redundancy, repetitive description of these similar features may not be made in some circumstances. It shall be understood, however, that description of a first-appearing feature applies to the later described similar feature and each respective description, therefore, is to be incorporated therein without such repetition.

Further aspects of the disclosure are provided by the subject matter of the following clauses.

An electronic lock comprising: an exterior housing defining a cavity; a lock core including a core spindle releasably coupled to a core shell, the core spindle and the core shell defining a key opening, the core spindle being rotatable within the core shell upon insertion of an authorized physical key into the key opening; an interior lock housing received within the cavity of the exterior housing, the interior core housing defining a cylindrical cavity, the cylindrical cavity receiving the lock core, the interior lock housing coupled to the lock core such that rotation of the interior lock housing causes rotation of the lock core within the exterior housing; a knob secured to the interior lock housing, the knob manually rotatable to rotate the interior lock housing and the lock core within the exterior housing; and an arming mechanism including an arming member, the arming member movable between an armed position and a disarmed position, wherein in the armed position, the arming member is engaged with the interior lock housing to prevent movement of the interior lock housing in relation to the exterior housing; wherein the knob is coupled to the interior housing by a torque limiting mechanism that allows the knob to rotate in relation to the interior lock housing when a twisting force applied to the knob exceeds a predetermined threshold.

The electronic lock according to any preceding clause, wherein the arming mechanism includes an electric motor and an arming member, the arming member being movable by the electric motor between the armed position and the disarmed position.

The electronic lock according to any preceding clause, wherein the arming member is a pin.

The electronic lock according to any preceding clause, wherein the arming mechanism includes a rack, and a pinion gear coupled to the motor.

The electronic lock according to any preceding clause, wherein the pinion gear is coupled to the motor via a planetary gear box.

The electronic lock according to any preceding clause, further including a centering mechanism for centering the interior lock housing within the exterior housing in at least one of a locked position and an unlocked position.

The electronic lock according to any preceding clause, wherein the centering mechanism includes a ball detent mechanism.

The electronic lock according to any preceding clause, wherein the electric motor is operable to move the arming member from the armed position to the disarmed position wirelessly using one of a key fob, an RFID tag, and a mobile device.

The electronic lock according to any preceding clause, further including a battery coupled to the electric motor to supply power to the electric motor.

The electronic lock according to any preceding clause, wherein the core spindle is coupled to the lock core by a pin assembly, and the authorized physical key is operable to uncouple the core spindle from the lock core to facilitate independent rotation of the core spindle.

The electronic lock according to any preceding clause, further including a driver coupled to the core spindle.

The electronic lock according to any preceding clause, further including a bolt coupled to the driver, wherein rotation of the core spindle moves the bolt between a locked position and an unlocked position.

An electronic lock comprising: an exterior housing defining a cavity; a lock core including a core spindle releasably coupled to a core shell, the lock core received within the cavity of the exterior housing, the core spindle and the core shell defining a key opening, the core spindle rotatable within the core shell upon insertion of an authorized physical key into the key opening; an interior lock housing received within the cavity of the exterior housing, the interior core housing defining a cylindrical cavity receiving the lock core, the interior lock housing coupled to the core shell such that rotation of the interior lock housing causes rotation of the lock core within the exterior housing; a bolt coupled to the core spindle and movable between a locked position and an unlocked position upon rotation of the core spindle; a knob secured to the interior lock housing, the knob being manually rotatable to rotate the interior lock housing and the lock core within the exterior housing; and an arming mechanism including an arming member, the arming member movable between an armed position and a disarmed position, wherein in the armed position, the arming member is engaged with the interior lock housing to prevent movement of the interior lock housing in relation to the exterior housing; wherein the core spindle is rotatable to move the bolt between the locked position and the unlocked position by rotating the core spindle in relation to the core shell using the authorized physical key or by rotating the knob to rotate the interior lock housing and the lock core without using the authorized physical key.

The electronic lock according to any preceding clause, wherein the arming mechanism includes an electric motor and an arming member, the arming member being movable by the electric motor between the armed position and the disarmed position.

The electronic lock according to any preceding clause, wherein the electric motor is operable to move the arming member from the armed position to the disarmed position wirelessly using one of a key fob, an RFID tag, and a mobile device.

The electronic lock according to any preceding clause, further including a battery to supply power to the electric motor.

The electronic lock according to any preceding clause, further including a centering mechanism for centering the interior lock housing within the exterior housing in at least one of a locked position and an unlocked position.

The electronic lock according to any preceding clause, wherein the knob is coupled to the interior housing by a torque limiting mechanism that allows the knob to rotate in relation to the interior lock housing when a twisting force applied to the knob exceeds a predetermined threshold.

The electronic lock according to any preceding clause, wherein the knob is coupled to the interior housing by a torque limiting mechanism that allows the knob to rotate in relation to the interior lock housing when a twisting force applied to the knob exceeds a predetermined threshold.

The electronic lock according to any preceding clause, wherein the core spindle is coupled to the lock core by a pin assembly, and the authorized physical key is operable to uncouple the core spindle from the lock core to facilitate independent rotation of the core spindle

The electronic lock according to any preceding clause, further including a driver coupled to the core spindle, the bolt coupled to the driver.

An electronic lock comprising: an exterior housing defining a cavity; an interior lock housing received within the cavity of the exterior housing, the interior core housing defining a cylindrical cavity; a lock core releasably supported within the cylindrical cavity of the interior lock housing, the lock core coupled to the interior lock housing such that rotation of the interior lock housing causes rotation of the lock core within the exterior housing; a main driver coupled to the lock core; a bolt coupled to the main driver; a knob secured to the interior lock housing, the knob manually rotatable to rotate the interior lock housing and the lock core within the exterior housing; and an arming mechanism including an arming member, the arming member initiated wirelessly to move between an armed position and a disarmed position, wherein in the armed position, the arming member is engaged with the interior lock housing to prevent movement of the interior lock housing in relation to the exterior housing.

An electronic lock comprising: an exterior housing defining a cavity; an interior lock housing received within the cavity of the exterior housing, the interior core housing defining a cavity; a lock core releasably supported within the cavity of the interior lock housing, the lock core coupled to the interior lock housing such that movement of the interior lock housing causes movement of the lock core within the exterior housing; a main driver coupled to the lock core; a knob secured to the interior lock housing, the knob manually movable to move the interior lock housing and the lock core within the exterior housing; and an arming mechanism including an arming member, the arming member initiated wirelessly to move between an armed position and a disarmed position, wherein in the armed position, the arming member is engaged with the interior lock housing to prevent movement of the interior lock housing in relation to the exterior housing.

Persons skilled in the art will understand that the structures and methods specifically described herein and shown in the accompanying figures are non-limiting exemplary aspects, and that the description, disclosure, and figures should be construed merely as exemplary of aspects. It is to be understood, therefore, that the disclosure is not limited to the precise aspects described, and that various other changes and modifications may be affected by one skilled in the art without departing from the scope or spirit of the disclosure. Additionally, the elements and features shown or described in connection with certain aspects may be combined with the elements and features of certain other aspects without departing from the scope of the disclosure, and that such modifications and variations are also included within the scope of the disclosure. Accordingly, the subject matter of the disclosure is not limited by what has been particularly shown and described.

What is claimed is:

1. An electronic lock comprising:
an exterior housing defining a cavity;
a lock core including a core spindle releasably coupled to a core shell, the core spindle and the core shell defining a key opening, the core spindle being rotatable within the core shell upon insertion of an authorized physical key into the key opening;
an interior lock housing received within the cavity of the exterior housing, the interior core housing defining a cylindrical cavity, the cylindrical cavity receiving the lock core, the interior lock housing coupled to the lock core such that rotation of the interior lock housing causes rotation of the lock core within the exterior housing;
a knob secured to the interior lock housing, the knob manually rotatable to rotate the interior lock housing and the lock core within the exterior housing; and
an arming mechanism including an arming member, the arming member movable between an armed position and a disarmed position, wherein in the armed position, the arming member is engaged with the interior lock housing to prevent movement of the interior lock housing in relation to the exterior housing;
wherein the knob is coupled to the interior housing by a torque limiting mechanism that allows the knob to rotate in relation to the interior lock housing when a twisting force applied to the knob exceeds a predetermined threshold.

2. The electronic lock of claim 1, wherein the arming mechanism includes an electric motor and an arming member, the arming member being movable by the electric motor between the armed position and the disarmed position.

3. The electronic lock of claim 2, wherein the arming member is a pin.

4. The electronic lock of claim 2, wherein the arming mechanism includes a rack, and a pinion gear coupled to the motor.

5. The electronic lock of claim 4, wherein the pinion gear is coupled to the motor via a planetary gear box.

6. The electronic lock of claim 1, further including a centering mechanism for centering the interior lock housing within the exterior housing in at least one of a locked position and an unlocked position.

7. The electronic lock of claim 6, wherein the centering mechanism includes a ball detent mechanism.

8. The electronic lock of claim 2, wherein the electric motor is operable to move the arming member from the armed position to the disarmed position wirelessly using one of a key fob, an RFID tag, and a mobile device.

9. The electronic lock of claim 2, further including a battery coupled to the electric motor to supply power to the electric motor.

10. The electronic lock of claim 1, wherein the core spindle is coupled to the lock core by a pin assembly, and the authorized physical key is operable to uncouple the core spindle from the lock core to facilitate independent rotation of the core spindle.

11. The electronic lock of claim 10, further including a driver coupled to the core spindle.

12. The electronic lock of claim 11, further including a bolt coupled to the driver, wherein rotation of the core spindle moves the bolt between a locked position and an unlocked position.

13. An electronic lock comprising:
an exterior housing defining a cavity;
a lock core including a core spindle releasably coupled to a core shell, the lock core received within the cavity of the exterior housing, the core spindle and the core shell defining a key opening, the core spindle rotatable within the core shell upon insertion of an authorized physical key into the key opening;
an interior lock housing received within the cavity of the exterior housing, the interior core housing defining a cylindrical cavity receiving the lock core, the interior lock housing coupled to the core shell such that rotation of the interior lock housing causes rotation of the lock core within the exterior housing;
a bolt coupled to the core spindle and movable between a locked position and an unlocked position upon rotation of the core spindle;
a knob secured to the interior lock housing, the knob being manually rotatable to rotate the interior lock housing and the lock core within the exterior housing; and
an arming mechanism including an arming member, the arming member movable between an armed position and a disarmed position, wherein in the armed position, the arming member is engaged with the interior lock housing to prevent movement of the interior lock housing in relation to the exterior housing;
wherein the core spindle is rotatable to move the bolt between the locked position and the unlocked position by rotating the core spindle in relation to the core shell using the authorized physical key or by rotating the knob to rotate the interior lock housing and the lock core without using the authorized physical key.

14. The electronic lock of claim 13, wherein the arming mechanism includes an electric motor and an arming member, the arming member being movable by the electric motor between the armed position and the disarmed position.

15. The electronic lock of claim 14, wherein the electric motor is operable to move the arming member from the armed position to the disarmed position wirelessly using one of a key fob, an RFID tag, and a mobile device.

16. The electronic lock of claim 15, further including a battery to supply power to the electric motor.

17. The electronic lock of claim 14, further including a centering mechanism for centering the interior lock housing within the exterior housing in at least one of a locked position and an unlocked position.

18. The electronic lock of claim 14, wherein the knob is coupled to the interior housing by a torque limiting mechanism that allows the knob to rotate in relation to the interior lock housing when a twisting force applied to the knob exceeds a predetermined threshold.

19. The electronic lock of claim 13, wherein the core spindle is coupled to the lock core by a pin assembly, and the authorized physical key is operable to uncouple the core spindle from the lock core to facilitate independent rotation of the core spindle.

20. An electronic lock comprising:
an exterior housing defining a cavity;
an interior lock housing received within the cavity of the exterior housing, the interior core housing defining a cavity;
a lock core releasably supported within the cavity of the interior lock housing, the lock core coupled to the interior lock housing such that movement of the interior lock housing causes movement of the lock core within the exterior housing;
a main driver coupled to the lock core;
a knob secured to the interior lock housing, the knob manually movable to move the interior lock housing and the lock core within the exterior housing; and
an arming mechanism including an arming member, the arming member initiated wirelessly to move between an armed position and a disarmed position, wherein in the armed position, the arming member is engaged with the interior lock housing to prevent movement of the interior lock housing in relation to the exterior housing.
